(19) United States
(12) Patent Application Publication
(10) Pub. No.: US 2013/0265150 A1
(43) Pub. Date: Oct. 10, 2013

(54) VEHICLE APPROACH NOTIFICATION UNIT

(71) Applicants: DENSO CORPORATION, Kariya-city (JP); HAMANAKODENSO CO., LTD., Kosai-city (JP)

(72) Inventors: Toshiaki NAKAYAMA, Miyoshi-city (JP); Koji SUZUKI, Hamamatsu-city (JP)

(73) Assignees: HAMANAKODENSO CO., LTD., Kosai-city (JP); DENSO CORPORATION, Kariya-city (JP)

(21) Appl. No.: 13/845,719

(22) Filed: Mar. 18, 2013

(30) Foreign Application Priority Data
Apr. 5, 2012 (JP) 2012-86808

(51) Int. Cl. B60Q 5/00

(52) U.S. Cl. CPC B60Q 5/008
USPC 340/425.5

(57) ABSTRACT

A vehicle approach notification unit is mounted to a sound tube of an electromagnetic warning device producing a warning sound, and includes a dynamic speaker that produces a notification sound notifying a presence of a vehicle. The dynamic speaker is mounted to the sound tube and outputs the notification sound through the sound tube to outside of the vehicle. The sound tube has a warning sound outlet at an end of the sound tube and a through hole at a position different from the warning sound outlet.

### CROSS REFERENCE TO RELATED APPLICATION

This application is based on Japanese Patent Application No. 2012-86808 filed on Apr. 5, 2012, the disclosure of which is incorporated herein by reference in its entirety.

### TECHNICAL FIELD

The present disclosure relates to a vehicle approach notification unit.

### BACKGROUND

Conventionally, a vehicle approach notification unit notifies people of an approaching vehicle with notification sound, and JP-10-201001A discloses such a vehicle approach notification unit having a dynamic speaker which directly produces sound with audible frequencies.

In conventional technologies, a vehicle approach notification unit has a dynamic speaker to make an approaching vehicle audible, and the dynamic speaker is required in addition to a vehicle horn producing warning sound, so an extra space is needed.

Notification sound notifying a presence of a vehicle is required not to be too loud, unlike warning sound, and artificial engine sound, chords, voice sound, and music are preferable as the notification sound. If the notification sound includes low frequencies under 600 Hz, the notification sound becomes quieter, but large dynamic speaker such as woofer is required to produce such low frequencies sound. So, large space and extra cost are needed.

In Japanese Patent Application No. 2011-238815 (U.S. patent application Ser. No. 13/662,913), a dynamic speaker is mounted to a sound tube of an electromagnetic warning device to produce warning sound in a vehicle, and emits notification sound out of the vehicle via the sound tube.

However, a directivity (audible range) of the notification sound is determined by a warning sound outlet such as an exit part of the sound tube which is defined at an end of the sound tube. Thus, when the sound tube mounts the dynamic speaker, it is difficult to control the directivity of the notification sound. In other words, the audible range of the notification sound is difficult to control and extend.

### SUMMARY

According to a first aspect of the present disclosure, a vehicle approach notification unit is mounted to a sound tube of an electromagnetic warning device producing a warning sound, and includes a dynamic speaker that produces a notification sound notifying a presence of a vehicle. The dynamic speaker is mounted to the sound tube and outputs the notification sound through the sound tube to outside of the vehicle. The sound tube has a warning sound outlet at an end of the sound tube and a through hole at a position different from the warning sound outlet.

According to a second aspect of the present disclosure, a vehicle approach notification unit is mounted to a sound tube of an electromagnetic warning device producing a warning sound, and includes a dynamic speaker that produces a notification sound notifying a presence of a vehicle. The vehicle has two of the electromagnetic warning devices, and the dynamic speaker is mounted to each of the two of the electromagnetic warning devices. The dynamic speaker outputs the notification sound having the same frequency from each of the two of the electromagnetic warning devices.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a front view illustrating an electromagnetic warning device having a vehicle approach notification unit according to a first embodiment, FIG. 1B is a sectional view illustrating the electromagnetic warning device, and FIG. 1C is a bottom view illustrating a sound tube of the electromagnetic warning device;

FIG. 2A is an explanatory view illustrating an audible range of a notification sound emitted from a sound tube without a through hole according to a comparison example, and FIG. 2B is an explanatory view illustrating an audible range of a notification sound emitted from a sound tube with a through hole according to the first embodiment;

FIG. 3 is a schematic block view illustrating the vehicle approach notification unit of the first embodiment;

FIG. 4A is a front view illustrating a first electromagnetic warning device having a vehicle approach notification unit according to a second embodiment, and FIG. 4B is a front view illustrating a second electromagnetic warning device having a vehicle approach notification unit according to a second embodiment;

FIG. 5 is a comparison view illustrating an audible range of a notification sound produced by a single electromagnetic warning device and an audible range of a notification sound produced by the first and second electromagnetic warning devices according to the second embodiment;

FIG. 6 is a graph illustrating a relationship between a sound pressure and an audible range of a notification sound emitted from the first and/or second electromagnetic warning devices according to the second embodiment; and

FIG. 7 is a schematic block view illustrating a vehicle approach notification unit according to a third embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

According to a first aspect of the present application, a vehicle approach notification unit has a dynamic speaker 3 producing a notification sound such as artificial engine sound, chord, voice sound or music. The dynamic speaker 3 is mounted to a sound tube 2 of an electromagnetic warning device 1. The sound tube 2 has a through hole β at a position different from a warning sound outlet α, and the notification sound is emitted out of the sound tube 2 through the through hole β.

According to a second aspect of the present disclosure, a vehicle has a first electromagnetic warning device 1A and a second electromagnetic warning device 1B. A vehicle approach notification unit has a dynamic speaker 3 mounted to the first electromagnetic warning device 1A and a dynamic speaker 3 mounted to the second electromagnetic warning device 1B. Both the dynamic speakers 3 output the notification sound having the same frequency.

### First Embodiment

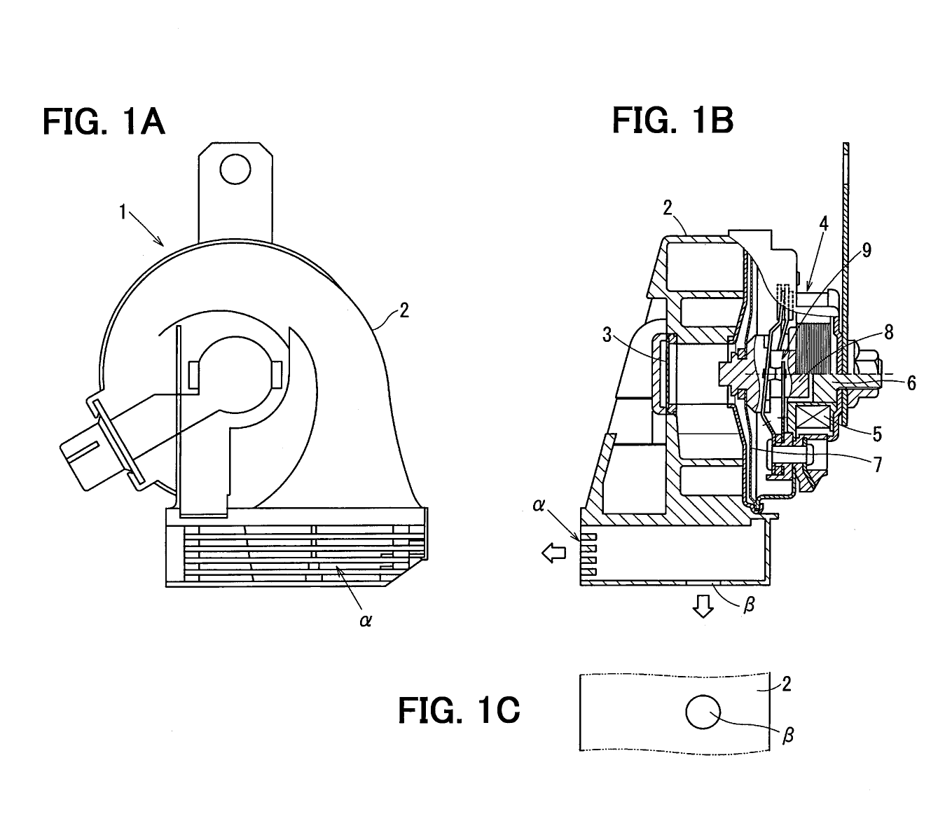

A first embodiment will be described with reference to FIGS. 1A, 1B, 2A, 2B, and 3.

A vehicle approach notification unit is mounted to a vehicle, and emits a notification sound to notify pedestrians of a presence of the vehicle. The vehicle may be an electric vehicle or a fuel cell vehicle with no engine, a hybrid vehicle in which an engine is stopped in a driving time and a stop time, an idling stop vehicle in which an engine is stopped in a stop time, or an engine vehicle which drives quietly with an engine.

The vehicle has an electromagnetic warning device 1 which generates a warning sound.

The electromagnetic warning device 1 is a vehicle horn producing a warning sound when a horn switch, which is mounted to a steering of the vehicle for example, is operated by an occupant. The electromagnetic warning device 1 is fixed, for example, between a front grille and a heat exchanger used for an air-conditioner such as radiator. The front grille is provided to an air intake port for a wind generated when the vehicle drives.

As shown in FIG. 1B, the electromagnetic warning device 1 includes a warning sound generator 4 and a sound tube 2 having a spiral shape. The warning sound generator 4 outputs a warning sound by being actuated. The sound tube 2 intensifies the warning sound generated by the warning sound generator 4, and emits the intensified warning sound.

The warning sound generator 4 includes a coil 5, a fixed iron-core 6, a movable iron-core 8, and a current interrupter 9. The coil 5 creates magnetic energy when current is applied. The fixed iron-core 6 may be an attraction core which creates magnetic attracting force when the magnetic energy is produced in the coil 5. The movable iron-core 8 is supported to a center of a diaphragm 7 and movable toward the fixed iron-core 6. The current interrupter 9 continuously intermittently interrupts the energization current in the coil 5 when the coil 5 is supplied with electricity.

The sound tube 2 is constructed by a trumpet portion in which a sound passage is enlarged from a horn inlet to a horn outlet α. Sound generated at the warning sound generator 4 enters the trumpet portion from the horn inlet and comes out of the horn outlet α. Moreover, the sound tube 2 is defined by a spiral horn which is produced by forming the trumpet portion into a spiral shape. The horn outlet a is defined by an open end of the sound tube 2.

The warning sound generator 4 is mounted to a side face of the sound tube 2, and is arranged to generate a warning sound into the horn inlet at the center part of the sound tube 2. The side face of the sound tube 2 is perpendicular to an axis of the spiral shape. For example, the side face of the sound tube 2 is located adjacent to the heat exchanger when the electromagnetic warning device 1 is mounted to the vehicle.

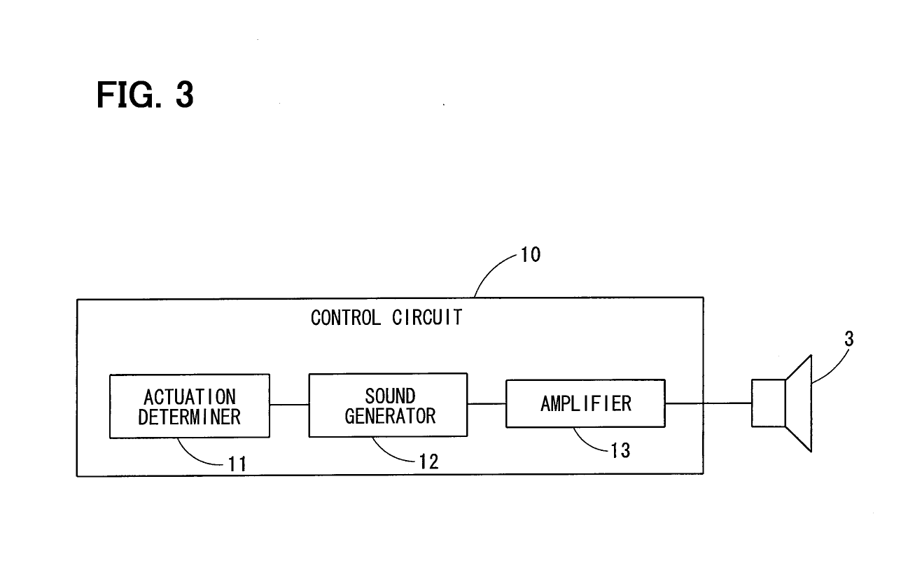

As shown in FIG. 3, the vehicle approach notification unit includes the dynamic (piezoelectric) speaker 3 producing notification sound with an audible frequency, and a control circuit 10 that controls the piezoelectric speaker 3. The piezoelectric speaker 3 is one example of the dynamic speaker, and the dynamic speaker is not limited to the piezoelectric speaker 3.

The piezoelectric speaker 3 has a vibration system constructed by a piezoelectric element and a diaphragm, and produces an audible frequency sound.

A primary resonance frequency of the vibration system is in the audible range, for example, about 2 kHz.

The piezoelectric element of the piezoelectric speaker 3 is displaced by the expansion or contraction depending on the applied voltage (charge/discharge). The diaphragm is actuated by the displacement of the piezoelectric element, and creates compression wave in the air.

Vehicle information is input from an engine control unit to the control circuit 10. The piezoelectric speaker 3 produces a notification sound when a driving condition is met to notify pedestrians of an approach of the vehicle.

The control circuit 10 includes an actuation determiner 11, a sound generator 12, and an amplifier 13, as shown in FIG. 3. The actuation determiner 11 determines if the driving condition is met or not to emit a notification sound. The sound generator 12 produces a frequency signal such as audible frequency signal to produce a notification sound when the actuation determiner 11 determines to produce the notification sound. The amplifier 13 amplifies the frequency signal output from the sound generator 12 and actuates the piezoelectric speaker 3.

The actuation determiner 11 determines that the driving condition is met and actuates the sound generator 12, for example, when a vehicle speed is under a predetermined value such as 20 km/h. This condition is just for an example, and not limited.

The sound generator 12 includes a notification sound produce program such as an acoustic software, and produces the audible frequency signal producing the notification sound, as an audio electric signal of an audible frequency, using digital technology when the actuation determiner 11 sends a signal to start operating to the sound generator 12.

The amplifier 13 is a power amplifier unit such as Class-B amplifier or Class-D amplifier, and actuates the piezoelectric speaker 3 with the frequency signal producing the notification sound produced by the sound generator 12. The amplifier 13 actuates the piezoelectric speaker 3 to produce the notification sound, as an audible sound, by controlling voltage applied to the piezoelectric speaker 3, in other words, by controlling the charge/discharge state of the piezoelectric element.

The piezoelectric speaker 3 is placed to be opposed to the warning sound generator 4 as shown in FIG. 1B, and arranged to generate a notification sound into the horn inlet at the center part of the sound tube 2.

The notification sound produced by the piezoelectric speaker 3 comes out of the vehicle through the sound tube 2. And then, a low frequency sound produced by the piezoelectric speaker 3 is amplified by the sound tube 2, and emitted out.

The warning sound outlet a of the sound tube 2 opens frontward in the vehicle so that the warning sound is emitted frontward from the vehicle.

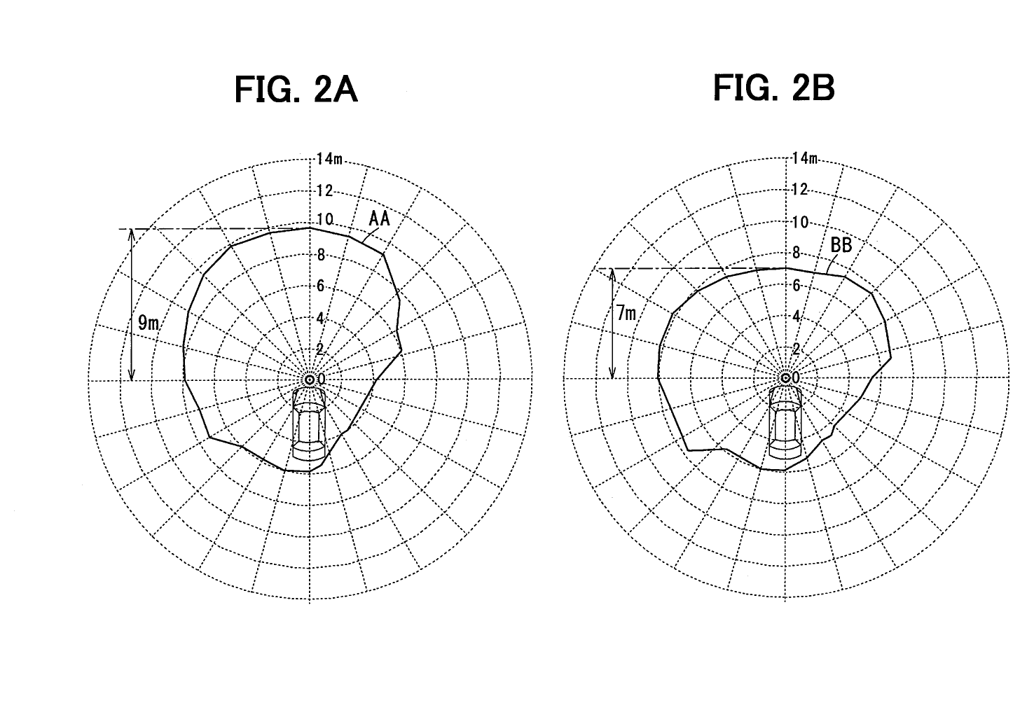

A line AA in FIG. 2A shows an audible range (directivity) of a notification sound emitted by only the warning sound outlet a as a comparison example. In this case, the audible range of the notification sound produced by the piezoelectric speaker 3 is determined by the warning sound outlet a of the sound tube 2.

In the comparison example, the audible range of the notification sound is not controllable when the piezoelectric speaker 3 is mounted to the sound tube 2. Specifically, the directivity of the notification sound is determined by the shape of the warning sound outlet a of the sound tube 2 and the open direction of the warning sound outlet a of the sound tube 2.

In the first embodiment, the sound tube 2 has a through hole 13 at a position different from the warning sound outlet α. For example, the through hole β is located at a middle in the sound passage of the sound tube 2 before the warning sound outlet α.

A notification sound is emitted from not only the warning sound outlet α, but also the through hole β as well, therefore the directivity of the notification sound can be controlled by an acoustic wave emitted from the through hole β. Specifically, the location, the open direction, the number, and the size of the through hole β determine a travel direction and amount of the notification sound.

In the first embodiment, one through hole β is placed at the bottom of the sound tube 2, near the warning sound outlet α as shown in FIGS. 1B and 10.

The through hole β emits notification sound, and the notification sound is reflected on the ground and scattered around the vehicle. In the result, an audible range of the notification sound is made uniform in the radial direction around the vehicle, as shown in a line BB in FIG. 2B, compared with the line AA in FIG. 2A.

According to the first embodiment, the vehicle approach notification unit emits a notification sound produced by the piezoelectric speaker 3 via the sound tube 2. The sound tube 2 has the through hole β aside from the warning sound outlet α, so the audible range of the notification sound can be made controllable.

The location, the number and the size of the through hole β can be easily changed by cut and shave processing. Thus, the directivity of the notification sound can be easily controlled by controlling the number and the size of the through hole β.

The vehicle approach notification unit in the first embodiment has the piezoelectric speaker 3 to produce a notification sound, and also has the sound tube 2 of the electromagnetic warning device 1 as described above. The sound pressure can be raised for a low frequency sound as well as a large-sized dynamic speaker such as a woofer.

Thus, the cost of the vehicle approach notification unit can be reduced, which produces a notification sound including a low frequency sound.

In the first embodiment, the piezoelectric speaker 3 producing an audible sound is used as an example of a small-sized dynamic speaker. The piezoelectric speaker 3 is small in cost, so a cost to produce the vehicle approach notification unit can be reduced.

The piezoelectric speaker 3 is smaller and lighter than a corn speaker, so the piezoelectric speaker 3 can be easily mounted to the electromagnetic warning device 1.

The piezoelectric speaker 3 is placed at a position opposing to the warning sound generator 4. Specifically, the warning sound generator 4 is mounted to a side face of the sound tube 2, and is arranged to generate a warning sound into the horn inlet at the center part of the sound tube 2. The side face of the sound tube 2 is perpendicular to an axis of the spiral shape. For example, the side face of the sound tube 2 is located adjacent to the front grille when the electromagnetic warning device 1 is mounted to the vehicle.

Because the piezoelectric speaker 3 is placed at a position opposing to the warning sound generator 4, the piezoelectric speaker 3 can be easily mounted to the sound tube 2. Moreover, the operation of the warning sound generator 4 is less affected by the piezoelectric speaker 3 which is mounted to the sound tube 2.

### Second Embodiment

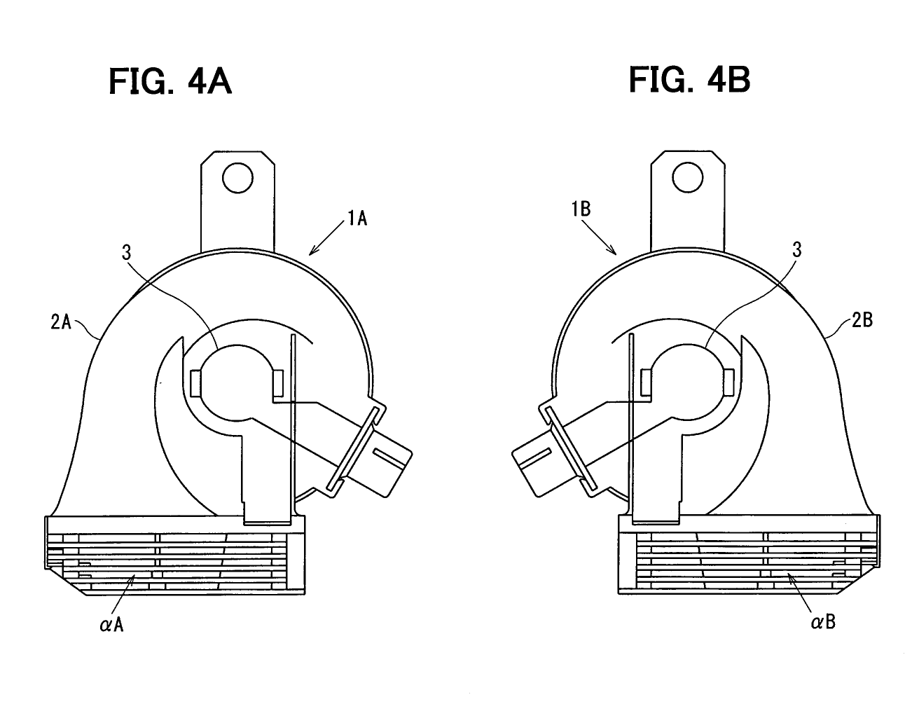

A second embodiment will be described with reference to FIGS. 4A, 4B, 5, and 6.

In the second embodiment, the directivity of the notification sound is raised to increase the audible range (distance) of the notification sound ahead of the vehicle, while the audible range of the notification sound is extended uniformly around the vehicle in the first embodiment.

Usually, a vehicle has two electromagnetic warning devices, which are constructed by a first electromagnetic warning device 1A shown in FIG. 4A and a second electromagnetic warning device 1B shown in FIG. 4B. The electromagnetic warning devices 1A, 1B produce a warning sound with different frequencies, so that the warning sound does not become annoying even if the warning sound is a loud sound.

In the second embodiment, a vehicle approach notification unit includes two dynamic (piezoelectric) speakers 3 mounted to the first electromagnetic warning device 1A and the second electromagnetic warning device 1B, respectively, as shown in FIGS. 4A and 4B. The first electromagnetic warning device 1A has a warning sound outlet αA and the second electromagnetic warning device 1B has a warning sound outlet αB, similar to the warning sound outlet α of the first embodiment. A first sound tube 2A of the first electromagnetic warning device 1A and a second sound tube 2B of the second electromagnetic warning device 1B do not have the through hole β of the first embodiment. However, the sound tube 2A, 2B may have the through hole β of the first embodiment.

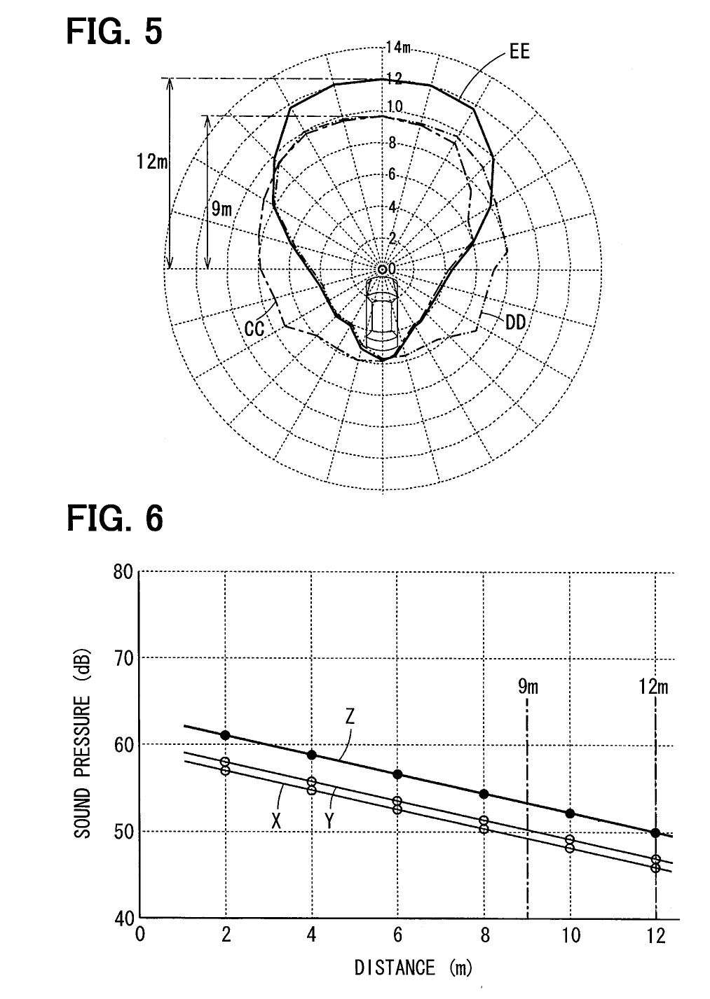

An example of an audible range of a notification sound is shown by an single chain line CC in FIG. 5 in case where only the piezoelectric speaker 3 mounted to the first electromagnetic warning device 1A produces the notification sound. An example of an audible range of a notification sound is shown by a double chain line DD in FIG. 5 in case where only the piezoelectric speaker 3 mounted to the second electromagnetic warning device 1B produces the notification sound.

When a predetermined condition is satisfied to notify pedestrians of an approaching vehicle, the control circuit 10 applies the same drive signal to the two piezoelectric speakers 3 respectively mounted to the first electromagnetic device 1A and the second electromagnetic device 1B. Each of the piezoelectric speakers 3 produces the notification sound with the same frequency.

Then, the notification sound emitted from the first sound tube 2A and the notification sound emitted from the second sound tube 2B interfere with each other in air, at a front of the vehicle to which the warning sound outlet a is opened. The interference produces a amplitude-synthetic wave in which the sound pressure of the notification sound is enhanced. In the result, as shown by a line EE in FIG. 5, the audible range of the notification sound is extended frontward from the vehicle, so the notification sound can be emitted to much far from the vehicle.

A comparison between the audible range CC or DD of notification sound produced by a single electromagnetic warning device 1A or 1B and the audible range EE of notification sound produced by the first and second electromagnetic warning devices 1A and 1B will be described with FIG. 6.

In FIG. 6, a solid line X represents a relationship between an audible distance ahead of the vehicle and a sound pressure of the notification sound when only the piezoelectric speaker 3 mounted to the first electromagnetic warning device 1A produces the notification sound. A solid line Y represents a relationship between an audible distance ahead of the vehicle and a sound pressure of the notification sound when only the piezoelectric speaker 3 mounted to the second electromagnetic warning device 1B produces the notification sound. A solid line Z represents a relationship between an audible distance ahead of the vehicle and a sound pressure of the notification sound when the two piezoelectric speakers 3 produce the notification sound having the same frequency.

As shown in FIG. 6, the directivity of the notification sound is enhanced in the second embodiment, so the audible distance ahead of the vehicle can be extended when both of the two piezoelectric speakers 3 are used to produce the notification sound having the same frequency.

### Third Embodiment

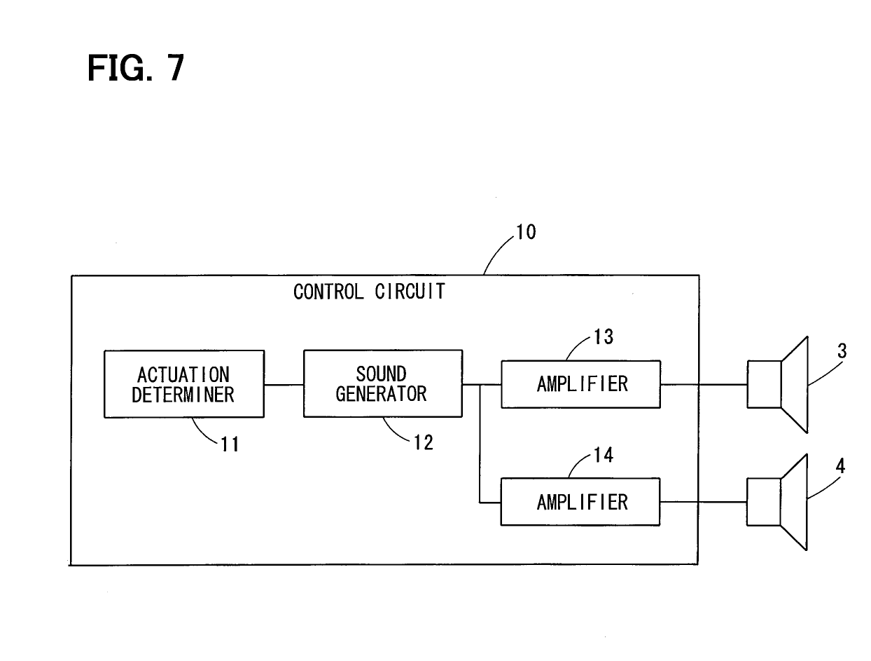

A third embodiment will be described with reference to FIG. 7 hereafter. The third embodiment is explained as a modification of the first embodiment, and is also applicable to each of the first embodiment and the second embodiment.

In the third embodiment, the control circuit 10 conducts the energization control for not only the piezoelectric speaker 3 but also the warning sound generator 4. The control circuit 10 applies a signal to the warning sound generator 4 to produce a warning sound having a high sound pressure when an occupant operates a horn switch. Moreover, each of the piezoelectric speaker 3 and the warning sound generator 4 produces a notification sound due to the control conducted by the control circuit 10.

Specifically, the current interrupter 9 intermittently interrupts current flowing in the coil 5 so as to produce a warning sound having a high sound pressure when self-excited voltage, which may be larger than or equal to a threshold value such as 8V, is applied to the warning sound generator 4.

When an occupant of the vehicle operates the horn switch, the control circuit 10 applies self-excited voltage such as battery voltage of 12V to the warning sound generator 4, and the electromagnetic warning device 1 produces a warning sound having a high sound pressure.

On the other hand, the current interrupter 9 does not intermittently interrupt current flowing in the coil 5 when separately-excited voltage, which is lower than the threshold value such as 8V, is applied to the warning sound generator 4. When the coil 5 is actuated by an audio signal with the separately-excited voltage, the diaphragm 7 vibrates in accordance with the audio signal and produces an acoustic wave corresponding to the audio signal. In other words, the warning sound generator 4 works as a dynamic speaker.

As shown in FIG. 7, the control circuit 10 of the third embodiment includes an amplifier 14 such as switching amplifier, aside from the amplifier 13. The frequency signal output from the sound generator 12 is amplified by the amplifier 14 to energize the coil 5 within the range of the separately-excited voltage, to produce the notification sound from the warning sound generator 4, at the same time as the notification sound is emitted from the piezoelectric speaker 3.

Thus, the sound pressure of the notification sound produced by both of the piezoelectric speaker 3 and the acoustic generator 4 is enhanced than that produced by the piezoelectric speaker 3 only.

### Other Embodiment

In the above embodiments, one piezoelectric speaker is mounted to the sound tube having the spiral shape. Alternatively, a plurality of the piezoelectric speakers may be mounted to the sound tube to enhance the sound pressure of the notification sound.

In the above embodiments, the piezoelectric speaker is used as an example of a dynamic speaker. Alternatively, other small-sized speaker such as small corn speaker which directly produces audible sound may be applicable.

In the above embodiments, a notification sound is produced by a dynamic speaker such as the piezoelectric speaker. Alternatively, a parametric speaker may be mounted to the vehicle approach notification unit, and both the notification sound produced by the dynamic speaker via the sound tube and the notification sound produced by the parametric speaker may be emitted out of the vehicle.

The dynamic speaker may be actuated when the warning sound generator is actuated, and a tone (frequency) of the warning sound may be controllable by the actuation of the dynamic speaker.

Such changes and modifications are to be understood as being within the scope of the present disclosure as defined by the appended claims.

What is claimed is:

1. A vehicle approach notification unit that is mounted to a sound tube of an electromagnetic warning device producing a warning sound, the vehicle approach notification unit comprising:
a dynamic speaker that produces a notification sound notifying a presence of a vehicle, wherein
the dynamic speaker is mounted to the sound tube and outputs the notification sound through the sound tube to outside of the vehicle, and
the sound tube has a warning sound outlet at an end of the sound tube and a through hole at a position different from the warning sound outlet.

2. The vehicle approach warning unit according to claim 1, wherein
the electromagnetic warning device has a warning sound generator which generates the warning sound, and
the dynamic speaker is different from the warning sound generator.

3. The vehicle approach warning unit according to claim 1,
wherein the dynamic speaker is a piezoelectric speaker which outputs an audible frequency sound.

4. The vehicle approach warning unit according to claim 2, wherein
the sound tube is a spiral-shaped horn, and
the dynamic speaker is located at a position opposite to the warning sound generator.

5. The vehicle approach warning unit according to claim 1, wherein
the dynamic speaker is one of two dynamic speakers,
the vehicle has two electromagnetic warning devices, and the two dynamic speakers are mounted to the two electromagnetic warning devices, respectively, and
the two dynamic speakers output the notification sound having the same frequency from the two electromagnetic warning devices, respectively.

6. A vehicle approach notification unit that is mounted to a sound tube of an electromagnetic warning device producing a warning sound, the vehicle approach notification unit comprising:
a dynamic speaker that produces a notification sound notifying a presence of a vehicle, wherein
the vehicle has two of the electromagnetic warning devices, and the dynamic speaker is mounted to each of the two of the electromagnetic warning devices, and
the dynamic speaker outputs the notification sound having the same frequency from each of the two of the electromagnetic warning devices.

7. The vehicle approach warning unit according to claim 6, wherein
the electromagnetic warning device has a warning sound generator which generates the warning sound, and
the dynamic speaker is different from the warning sound generator.

8. The vehicle approach warning unit according to claim 6,
wherein the dynamic speaker is a piezoelectric speaker which outputs an audible frequency sound.

9. The vehicle approach warning unit according to claim 7, wherein
the sound tube is a spiral-shaped horn, and
the dynamic speaker is located at a position opposite to the warning sound generator.

10. The vehicle approach warning unit according to claim 6,
each of the two of the dynamic speakers outputs the notification sound through the sound tube to outside of the vehicle, and
the sound tube has a warning sound outlet at an end of the sound tube and a through hole at a position different from the warning sound outlet.
